(19) United States
(12) Patent Application Publication
(10) Pub. No.: US 2026/0049699 A1
(43) Pub. Date: Feb. 19, 2026

(54) LIGHT-EMITTING MODULE

(71) Applicant: Primax Electronics Ltd., Taipei (TW)

(72) Inventors: Yu-Zeng Yang, Taipei (TW); Chin-Sung Pan, Taipei (TW); I-Hsiang Ko, Taipei (TW)

(21) Appl. No.: 19/072,350

(22) Filed: Mar. 6, 2025

Related U.S. Application Data
(60) Provisional application No. 63/683,201, filed on Aug. 14, 2024.

(51) Int. Cl. F21S 4/24; F21V 23/00; F21V 23/06; F21Y 103/10; F21Y 115/10

(52) U.S. Cl. CPC F21S 4/24; F21V 23/002; F21V 23/006; F21V 23/06; F21Y 2103/10; F21Y 2115/10

(57) ABSTRACT

A light-emitting module includes a light bar and a flexible flat cable (FFC). The light bar includes a first flexible substrate, a printed circuit and a plurality of light-emitting elements. The printed circuit is disposed on the first flexible substrate, in which the printed circuit has a plurality of first contacts. The light-emitting elements are disposed on the first flexible substrate and electrically connected to the printed circuit. The flexible flat cable includes a second flexible substrate and a connecting circuit. The connecting circuit is disposed on the second flexible substrate, in which electrical resistivity of the printed circuit at room temperature is greater than electrical resistivity of the connecting circuit at room temperature, and the connecting circuit has a plurality of second contacts respectively corresponding to the first contacts, and the second contacts are electrically connected to the first contacts, respectively.

### RELATED APPLICATIONS

This application claims priority to U.S. Provisional Application Ser. No. 63/683,201, filed Aug. 14, 2024, which is herein incorporated by reference.

### FIELD OF THE INVENTION

The present invention relates to a light-emitting module.

### BACKGROUND OF THE INVENTION

In a conventional light-emitting module, light-emitting elements are mounted on a flexible printed circuit board (FPC). Circuits of the flexible printed circuit board are formed through a copper foil etching process. However, since the copper foil etching process is expensive and causes serious environmental pollution, there is an urgent need for a light-emitting module that does not require the copper foil etching process.

### SUMMARY OF THE INVENTION

The present invention provides a light-emitting module, which includes a light bar and a flexible flat cable (FFC). The light bar includes a first flexible substrate, a printed circuit and a plurality of light-emitting elements. The printed circuit is disposed on the first flexible substrate, in which the printed circuit has a plurality of first contacts. The light-emitting elements are disposed on the first flexible substrate and electrically connected to the printed circuit. The flexible flat cable includes a second flexible substrate and a connecting circuit. The connecting circuit is disposed on the second flexible substrate, in which electrical resistivity of the printed circuit at room temperature is greater than electrical resistivity of the connecting circuit at room temperature, and the connecting circuit has a plurality of second contacts respectively corresponding to the first contacts, and the second contacts are electrically connected to the first contacts, respectively.

In some embodiments of the present invention, the electrical resistivity of the printed circuit at room temperature is greater than or equal to 1.0×10⁻⁷ Ω·m, and a ratio of the electrical resistivity of the connecting circuit at room temperature to the electrical resistivity of the printed circuit at room temperature is less than or equal to 0.3.

In some embodiments of the present invention, the light-emitting elements are connected in parallel through the printed circuit.

In some embodiments of the present invention, the light-emitting elements are connected in series through the printed circuit.

In some embodiments of the present invention, at least one of the light-emitting elements is electrically connected to the printed circuit by reflow soldering.

In some embodiments of the present invention, the printed circuit is made of a conductive paste, and the connecting circuit is made of a rolled metal.

In some embodiments of the present invention, at least one of the light-emitting elements is an IC-embedded light-emitting diode.

In some embodiments of the present invention, the IC-embedded light-emitting diode has a power supply terminal, a ground terminal, a data input terminal and a data output terminal.

In some embodiments of the present invention, the printed circuit includes a power line, a ground line and a data line electrically connected to the IC embedded light-emitting diode.

In some embodiments of the present invention, the IC-embedded light-emitting diode is an IC-embedded multi-color light-emitting diode.

In some embodiments of the present invention, the light-emitting elements are a plurality of IC-embedded light-emitting diodes, and the printed circuit includes a power line, a ground line and a data line, and the IC-embedded light-emitting diodes are connected in series through the data line, and the power line is connected in parallel to the IC-embedded light-emitting diodes, and the ground line is connected in parallel to the IC-embedded light-emitting diodes.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a three-dimensional schematic diagram of a light-emitting module according to an embodiment of the present invention.

FIG. 2 is an exploded view of the light-emitting module of FIG. 1.

FIG. 3 is an exemplary circuit diagram of a printed circuit and a connecting circuit according to an embodiment of the present invention.

FIG. 4 is an exemplary circuit diagram of a printed circuit and a connecting circuit according to an embodiment of the present invention.

FIG. 5 is an exemplary circuit diagram of a printed circuit and a connecting circuit according to an embodiment of the present invention.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over. ” The spatially relative descriptions used herein should be interpreted the same.

As mentioned in the prior art, in a conventional light-emitting module, light-emitting elements are mounted on a flexible printed circuit board (FPC). Circuits of the flexible printed circuit board are formed through a copper foil etching process. However, since the copper foil etching process is expensive and causes serious environmental pollution, there is an urgent need for a light-emitting module that does not require the copper foil etching process. Accordingly, the present invention provides a light-emitting module, which includes a light bar and a flexible flat cable (FFC). The light bar includes a first flexible substrate, a printed circuit and a plurality of light-emitting elements. The flexible flat cable includes a second flexible substrate and a connecting circuit. Electrical resistivity of the printed circuit at room temperature is greater than electrical resistivity of the connecting circuit at room temperature. Since the light-emitting module of the present invention adopts the printed circuit, its manufacturing process is more environmentally friendly and has lower cost, thus effectively solving the issues mentioned in the prior art. Although the printed circuit of the present invention (which is electrically connected to the light-emitting elements) has higher electrical resistivity and higher impedance, the printed circuit is electrically connected to the connecting circuit with lower electrical resistivity, a voltage drop of the connecting circuit is low, and thus an input voltage of the light bar will not drop significantly. Various embodiments of the light-emitting module of the present invention are described in detail below.

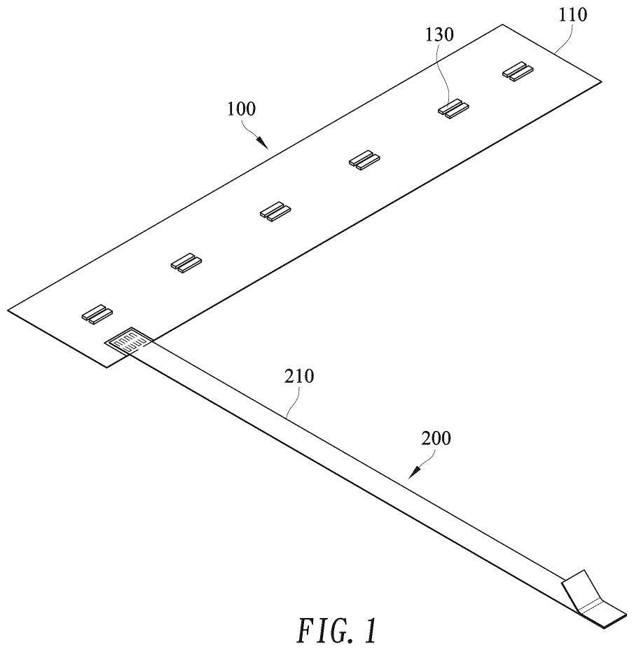

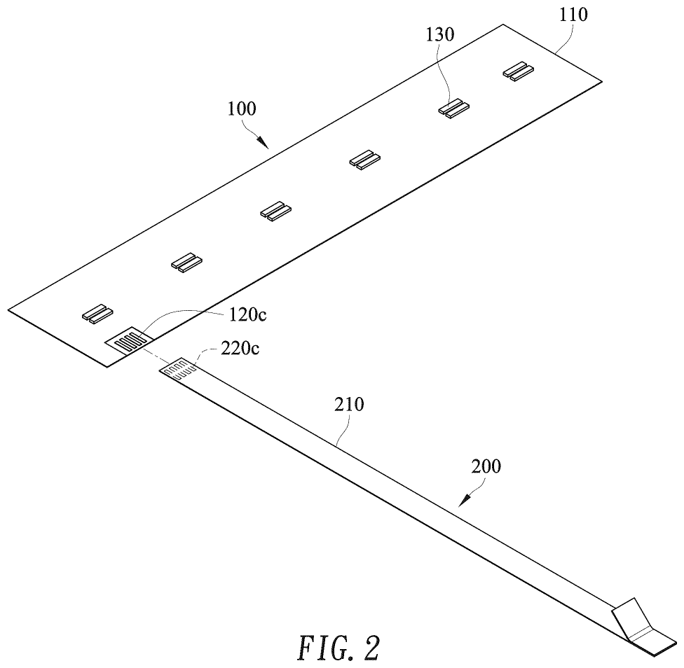

FIG. 1 is a three-dimensional schematic diagram of a light-emitting module according to an embodiment of the present invention. FIG. 2 is an exploded view of the light-emitting module of FIG. 1. As shown in FIGS. 1 and 2, the light-emitting module includes a light bar 100 and a flexible flat cable 200.

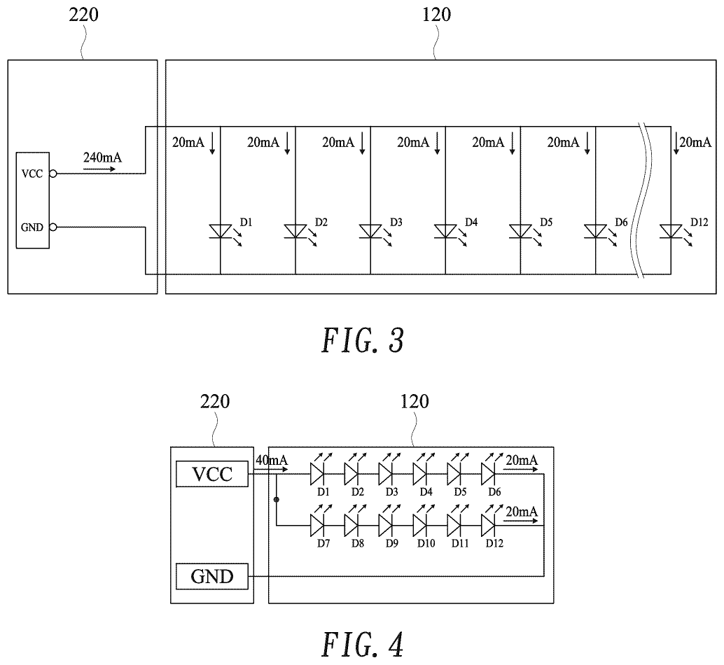

FIG. 3 is an exemplary circuit diagram of a printed circuit and a connecting circuit according to an embodiment of the present invention. Referring to FIGS. 1 to 3, the light bar 100 includes a first flexible substrate 110, a printed circuit 120 and a plurality of light-emitting elements 130. In some embodiments, the first flexible substrate 110 is a substrate made of thermoplastic resin (e.g., polyethylene terephthalate (PET)), thermosetting resin (e.g., polyimide (PI)), or other suitable insulating materials.

Referring to FIGS. 1 and 3, the printed circuit 120 is disposed on the first flexible substrate 110. In some embodiments, electrical resistivity of the printed circuit 120 at room temperature (between 15° C. and 30° C., such as 25° C.) is greater than or equal to 1.0×10⁻⁷ Ω·m. In some embodiments, the electrical resistivity of the printed circuit 120 at room temperature is greater than or equal to 2×10⁻⁷ Ω·m, 3×10⁻⁷ Ω·m, 4×10⁻⁷ Ω·m, 5×10⁻⁷ Ω·m, 6×10⁻⁷ Ω·m, 7×10⁻⁷ Ω·m, 8×10⁻⁷ Ω·m, 9×10⁻⁷ Ω·m, 1×10⁻⁶ Ω·m, 1.1×10⁻⁶ Ω·m, 1.2×10⁻⁶ Ω·m, 1.3×10⁻⁶ Ω·m, 1.4×10⁻⁶ or Ω·m, 1.5×10⁻⁶ Ω·m. In some embodiments, the printed circuit 120 is made of a conductive paste (e.g., silver paste, copper paste, or other suitable metal paste). However, the present invention is not limited to the aforementioned embodiments. In other embodiments, the printed circuit 120 may be made of another material, such as conductive carbon ink, solder paste, etc.

Referring to FIGS. 2 and 3, the printed circuit 120 has a plurality of first contacts 120c, which are configured to be electrically connected to a plurality of second contacts 220c of the flexible flat cable 200, so that the light bar 100 is electrically connected to the flexible flat cable 200.

Referring to FIGS. 1 and 3, the light-emitting elements (e.g., light-emitting diodes) 130 are disposed on the first flexible substrate 110 and electrically connected to the printed circuit 120. In some embodiments, at least one of the light-emitting elements 130 is electrically connected to the printed circuit 120 by reflow soldering. Compared with a bonding process of silver glue curing, the reflow soldering process is less expensive and can be applied to mass production. However, the present invention is not limited to the aforementioned embodiments. In other embodiments, the light-emitting element 130 may be electrically connected to the printed circuit 120 through a bonding process of silver paste curing.

Referring to FIGS. 1 and 3, the flexible flat cable 200 includes a second flexible substrate 210 and a connecting circuit 220. In some embodiments, the second flexible substrate 210 is a substrate made of thermoplastic resin (e.g., polyethylene terephthalate), thermosetting resin (e.g., polyimide), or other suitable insulating materials.

Referring to FIGS. 1 and 3, the connecting circuit 220 is disposed on the second flexible substrate 210. The electrical resistivity of the printed circuit 120 at room temperature (between 15° C. and 30° C., such as 25° C.) is greater than electrical resistivity of the connecting circuit 220 at room temperature (between 15° C. and 30° C., such as 25° C.). In some embodiments, a ratio of the electrical resistivity of the connecting circuit 220 at room temperature to the electrical resistivity of the printed circuit 120 at room temperature is less than or equal to 0.3. In some embodiments, the ratio of the electrical resistivity of the connecting circuit 220 at room temperature to the electrical resistivity of the printed circuit 120 at room temperature is less than or equal to 0.29, 0.28, 0.27, 0.26, 0.25, 0.24, 0.23, 0.22, 0.21, 0.20, 0.19, 0.18, 0.17, 0.16, 0.15, 0.14, 0.13, 0.12, 0.11, 0.10, 0.09, 0.08, 0.07, 0.06, 0.05 , 0.04, 0.03, 0.02, 0.019, 0.018, 0.017, 0.016, 0.015, 0.014, 0.013, 0.012, 0.011 or 0.010. In some embodiments, the electrical resistivity of the connecting circuit 220 at room temperature (between 15° C. and 30° C., such as 25° C.) is less than or equal to 3.0×10⁻⁸ Ω·m, 2.9×10⁻⁸ Ω·m, 2.8×10⁻⁸ Ω·m, 2.70×10⁻⁸ Ω·m, 2.6×10⁻⁸ Ω·m, 2.5×10⁻⁸ Ω·m, 2.4×10⁻⁸ Ω·m, 2.3×10⁻⁸ Ω·m, 2.2×10⁻⁸ Ω·m, 2.1×10⁻⁸ Ω·m, 2.9×10⁻⁸ Ω·m, 1.9×10⁻⁸ Ω·m, 1.8×10⁻⁸ Ω·m, 1.7×10⁻⁸ Ω·m. In some embodiments, the connecting circuit 220 is made of a rolled metal, so even if the flexible flat cable 200 is folded, the impedance of the connecting circuit 220 will not increase or even cause the connecting circuit 220 to be broken.

Referring to FIGS. 2 and 3, the connecting circuit 220 has a plurality of second contacts 220c respectively corresponding to the first contacts 120c, and the second contacts 220c are respectively electrically connected to the first contacts 120c. In some embodiments, the second contacts 220c are electrically connected to the first contacts 120c respectively through soldering.

Referring to FIGS. 1 and 3, in some embodiments, a total current is designed to be 240 mA, and the light-emitting elements 130 (e.g., twelve light-emitting elements) are connected in parallel through the printed circuit 120, and each of the light-emitting elements 130 is allocated 20 mA. However, the present invention is not limited to the above embodiments, and the total current can be designed according to a number of the light-emitting elements 130 and a current required by each of the light-emitting elements 130.

It is worth noting that although the flexible flat cable 200 of the present invention can be replaced by a flexible printed circuit board, the flexible flat cable 200 of the present invention has advantages of lower cost and environmentally friendly manufacturing process.

FIG. 4 is an exemplary circuit diagram of a printed circuit and a connecting circuit according to an embodiment of the present invention. Referring to FIGS. 1 and 4, the light-emitting elements 130 are connected in series through the printed circuit 120, so that a total current can be reduced (e.g., the total current is 40 mA), and a voltage drop of the printed circuit 120 is greatly reduced. The series connection characteristic allows the light-emitting elements 130 to have the same current (e.g., the current is 20 mA), so that the light-emitting brightness of the light-emitting elements 130 is more consistent.

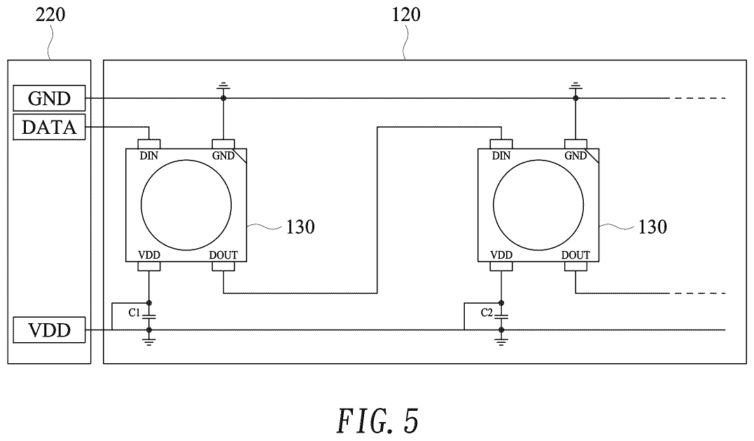

FIG. 5 is an exemplary circuit diagram of a printed circuit and a connecting circuit according to an embodiment of the present invention. Referring to FIGS. 1 and 5, at least one of the light-emitting elements 130 is an IC embedded light-emitting diode, which is an embedded controlled light-emitting diode in which a control circuit and a light-emitting circuit are integrated. In some embodiments, a light-emitting unit and a driving unit are packaged together, and the driving unit provides a stable current to the light-emitting unit, so that the IC embedded light-emitting diode has a constant current characteristic. As a result, even if the impedance of the printed circuit 120 is larger, it will not affect the light-emitting brightness and light-emitting color of the IC embedded light-emitting diode.

In some embodiments, as shown in FIG. 5, the IC embedded light-emitting diode has a power supply terminal (VDD), a ground terminal (GND), a data input terminal (Din) and a data output terminal (Dout). In some embodiments, the printed circuit 120 includes a power line (VDD), a ground line (GND), and a data line (DATA), which are electrically connected to the IC embedded light-emitting diode. In some embodiments, the connecting circuit 220 includes a power line (VDD), a ground line (GND), and a data line (DATA); the connecting circuit 220 is electrically connected to a controller (not shown). The controller may be, but is not limited to, a microcontroller unit (MCU).

In some embodiments, referring to FIGS. 1 and 5, the light-emitting elements 130 are a plurality of IC-embedded light-emitting diodes, and the printed circuit 120 includes a power line (VDD), a ground line (GND) and a data line (DATA). The IC-embedded light-emitting diodes are connected in series through the data line (DATA), and the power line (VDD) is connected in parallel to the IC-embedded light-emitting diodes, and the ground line (GND) is connected in parallel to the IC-embedded light-emitting diodes.

In some embodiments, the IC embedded light-emitting diode is an IC embedded multi-color light-emitting diode (e.g., an IC embedded RGB light-emitting diode). However, the present invention is not limited to the above embodiments. In other embodiments, the IC embedded light-emitting diode may be an IC embedded single-color light-emitting diode or an IC embedded invisible light light-emitting diode.

It is worth noting that, generally, if a plurality of multi-color LEDs are to be provided, and each of the multi-color LEDs is independently controlled through an external driver chip, since each of the multi-color LEDs requires a circuit connected to a positive electrode and a plurality of circuits (e.g., three circuits) connected to a negative electrode, a number of circuits is extremely large, resulting in a very complicated circuit layout and the need to use jumper structures. However, since the present invention adopts the IC embedded multi-color light-emitting diodes, the printed circuit 120 only needs to include the power line (VDD), the ground line (GND) and the data line (DATA). A number of lines is very small and there is no need to use jumper structures. Therefore, the printed circuit 120 of the light bar 100 can be a single-layer circuit design.

The light-emitting module of the present invention can be applied to various electronic products that require light emission, such as a keyboard. In some embodiments, the light-emitting module of the present invention may be used in conjunction with a light guide plate (not shown), or may be designed so that one or each key of a keyboard corresponds to one or more light-emitting elements. In some embodiments, the light-emitting element 130 of the light-emitting module of the present invention may be surrounded by a light shielding structure (e.g., a black packaging housing, adhesive) or an external light blocking structure (e.g., Mylar, an iron plate structure, a light angle adjustment layer) to reduce light leakage.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

What is claimed is:

1. A light-emitting module, comprising:
a light bar, comprising:
a first flexible substrate;
a printed circuit, disposed on the first flexible substrate, wherein the printed circuit has a plurality of first contacts; and
a plurality of light-emitting elements, disposed on the first flexible substrate and electrically connected to the printed circuit; and
a flexible flat cable (FFC), comprising:
a second flexible substrate; and
a connecting circuit, disposed on the second flexible substrate, wherein electrical resistivity of the printed circuit at room temperature is greater than electrical resistivity of the connecting circuit at room temperature, and the connecting circuit has a plurality of second contacts respectively corresponding to the first contacts, and the second contacts are electrically connected to the first contacts, respectively.

2. The light-emitting module of claim 1, wherein the electrical resistivity of the printed circuit at room temperature is greater than or equal to 1.0×10⁻⁷ Ω·m, and a ratio of the electrical resistivity of the connecting circuit at room temperature to the electrical resistivity of the printed circuit at room temperature is less than or equal to 0.3.

3. The light-emitting module of claim 1, wherein the light-emitting elements are connected in parallel through the printed circuit.

4. The light-emitting module of claim 1, wherein the light-emitting elements are connected in series through the printed circuit.

5. The light-emitting module of claim 1, wherein at least one of the light-emitting elements is electrically connected to the printed circuit by reflow soldering.

6. The light-emitting module of claim 1, wherein the printed circuit is made of a conductive paste, and the connecting circuit is made of a rolled metal.

7. The light-emitting module of claim 1, wherein at least one of the light-emitting elements is an IC-embedded light-emitting diode.

8. The light-emitting module of claim 7, wherein the IC-embedded light-emitting diode has a power supply terminal, a ground terminal, a data input terminal and a data output terminal.

9. The light-emitting module of claim 7, wherein the printed circuit comprises a power line, a ground line and a data line electrically connected to the IC embedded light-emitting diode.

10. The light-emitting module of claim 7, wherein the IC-embedded light-emitting diode is an IC-embedded multi-color light-emitting diode.

11. The light-emitting module of claim 1, wherein the light-emitting elements are a plurality of IC-embedded light-emitting diodes, and the printed circuit comprises a power line, a ground line and a data line, and the IC-embedded light-emitting diodes are connected in series through the data line, and the power line is connected in parallel to the IC-embedded light-emitting diodes, and the ground line is connected in parallel to the IC-embedded light-emitting diodes.
